(19) United States
(12) Patent Application Publication
(10) Pub. No.: US 2014/0064345 A1
(43) Pub. Date: Mar. 6, 2014

(54) SIGNAL PROCESSING APPARATUS AND METHOD

(71) Applicant: FUJITSU LIMITED, Kawasaki (JP)

(72) Inventors: Kiichi Sugitani, Fukuoka (JP); Eri Katayama, Fukuoka (JP); Kazunari Shiota, Kasuga (JP); Hisao Nakashima, Kawasaki (JP); Takeshi Hoshida, Kawasaki (JP)

(73) Assignee: FUJITSU LIMITED, Kawasaki (JP)

(21) Appl. No.: 13/953,181

(22) Filed: Jul. 29, 2013

(30) Foreign Application Priority Data
Sep. 3, 2012 (JP) 2012-193614

(51) Int. Cl. H04B 10/61

(52) U.S. Cl. CPC H04B 10/616
USPC 375/224; 375/232

(57) ABSTRACT

A signal processing apparatus includes a number P of adaptive equalization filters, P being 2 or more, configured to execute a first computing process for equalization on respective input signals, and to issue output signals; a number N of error calculation circuits, N being not more than P, configured to determine, per adaptive equalization filter, a second computing process to calculate an error in order to reduce a difference between a value of the output signal obtained with the first computing process and a predetermined objective value of the output signal; and an update circuit configured to determine a third computing process based on the second computing process determined per adaptive equalization filter by the error calculation circuit, and to update a computing process, which is executed in the adaptive equalization filter, to the third computing process.

### CROSS-REFERENCE TO RELATED APPLICATION

This application is based upon and claims the benefit of priority of the prior Japanese Patent Application No. 2012-193614 filed on Sep. 3, 2012, the entire contents of which are incorporated herein by reference.

### FIELD

The embodiments discussed herein are related to a signal processing apparatus and method.

### BACKGROUND

Recently, a digital coherent optical receiving method in combination of a coherent optical receiving method and a digital signal processing technology has captured attention as an optical communication technology in the next generation. Polarization multiplexing using a Horizontal (H) polarization and a Vertical (V) polarization, which are orthogonal to each other, is practiced in some optical communication systems employing the digital coherent optical receiving method. With the polarization multiplexing technology, high-speed communication is realized while a transmission rate per polarization is reduced.

In coherent optical communication utilizing the polarization multiplexing technology, a polarization multiplexed signal transmitted via a transmission path is subjected to polarization demultiplexing on the receiving side. A polarization demultiplexing circuit is realized with a butterfly-type Finite Impulse Response (FIR) filter of 2×2, for example.

When the polarization demultiplexing is performed using the butterfly-type FIR filter, a method for updating coefficients of individual FIR filters is employed such that an output signal comes closer to an objective value.

Known polarization demultiplexing methods for updating the filter coefficients such that an output signal comes closer to an objective value include, for example, Constant Modulus Algorithm (CMA) method, Multi-Modulus Algorithm (MMA) method, and Radius Directed Equalization (RDE) method. (See, for example, Japanese Laid-open Patent Publication No. 2009-296596, “Blind Equalization Using the Constant Modulus Criterion”, C, Richard Johnson, Jr. et al, in Proceedings of the IEEE, vol. 86, no. 10, October 1998, “A New Dual-Mode Approach to Blind Equalization Of QAM Signals”, M. Shahmohammadi and M. H. Kahaei, Proc. IEEE 8th Int'l Symp. Computers & Communication, 2003, pp. 277-281, and “Blind Equalization Based on Radius Directed Adaptation”, Michel J. Ready and Richard P. Gooch, Proc. IEEE ICASSP, April 1990, pp. 1699-1702.

Polarization demultiplexing circuits are incorporated in a parallel developed form due to restrictions imposed when incorporating the circuits. More specifically, when the transmission rate is high, it is difficult to process signals with the current technology by inputting the signals to a large-scale integrated circuit, which incorporates one polarization demultiplexing circuit. Therefore, the signals are processed by distributing the signals to many polarization demultiplexing circuits in the parallel developed form and reducing a frequency of the signal processed by one polarization demultiplexing circuit. In that case, because the polarization demultiplexing circuit executes computation using a filter coefficient per clock, the butterfly-type FIR filter, for example, is incorporated for each of all the polarization demultiplexing circuits (for each of all lanes) in the parallel developed form.

On the other hand, when the above-mentioned method for updating the filter coefficient is employed in performing the polarization demultiplexing, an update control circuit for updating the filter coefficient is used to detect and control an optimum polarization state. To that end, the update control circuit may also be incorporated for each of all lanes of the polarization demultiplexing circuits.

However, the number of update control circuits to be incorporated is often reduced due to restrictions taking into account the current technical level of integrated circuits and combined arrangement with other signal processing circuits. Reducing the number of update control circuits to be incorporated raises the problem that an output signal is not sufficiently controlled and a satisfactory characteristic is not obtained in the polarization demultiplexing.

In a signal processing circuit for executing a computing process on an input signal, updating the computing process based on a computation result, and further repeating the updated computing process, a similar problem occurs when an update control circuit for controlling update of the computing process is provided. Stated in another way, an output characteristic may degrade when the update control circuit is provided in smaller number than the signal processing circuit for executing the computing process.

### SUMMARY

According to an aspect of the embodiment, a signal processing apparatus includes a number P of adaptive equalization filters, P being 2 or more, configured to execute a first computing process for equalization on respective input signals, and to issue output signals; a number N of error calculation circuits, N being not more than P, configured to determine, per adaptive equalization filter, a second computing process to calculate an error in order to reduce a difference between a value of the output signal obtained with the first computing process and a predetermined objective value of the output signal; and an update circuit configured to determine a third computing process based on the second computing process determined per adaptive equalization filter by the error calculation circuit, and to update a computing process, which is executed in the adaptive equalization filter, to the third computing process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of configuration of an optical communication system according to a first embodiment;

FIG. 2 illustrates an example of configuration of a digital signal processing circuit according to the first embodiment;

FIG. 3 illustrates an example of configuration of a polarization demultiplexing circuit including an adaptive equalization filter and a coefficient calculation circuit;

FIG. 4 illustrates an example of configuration of the adaptive equalization filter according to the first embodiment;

FIG. 5 illustrates an example of configuration of an FIR filter according to the first embodiment;

FIG. 6 illustrates an example of configuration of a Serial Parallel conversion circuit (S/P) and a digital signal processing circuit according to the first embodiment;

FIG. 7 illustrates an example of configuration of a polarization demultiplexing circuit including an adaptive equalization filter and an error calculation circuit in one-to-one relation;

FIG. 8 illustrates the configuration and the processing of the polarization demultiplexing circuit according to the first embodiment;

FIG. 9 illustrates dependency of signal quality of an output of the polarization demultiplexing circuit upon a delay time and an averaging number;

FIG. 10 is a time chart for a signal processing method according to the first embodiment;

FIG. 11 illustrates signal quality of the output of the polarization demultiplexing circuit according to the first embodiment;

FIG. 12 illustrates the configuration and the processing of a polarization demultiplexing circuit according to a first modification;

FIG. 13 is a time chart for a signal processing method according to the first modification;

FIG. 14 illustrates the configuration and the processing of a polarization demultiplexing circuit according to a second embodiment; and

FIG. 15 illustrates a modification of the configuration of the adaptive equalization filter.

### DESCRIPTION OF EMBODIMENTS

Hereinafter, a signal processing circuit according to a first embodiment will be described below with reference to the drawings. In the following first embodiment, a digital signal processing circuit for use in a digital coherent optical receiver is described as an example of the signal processing circuit.

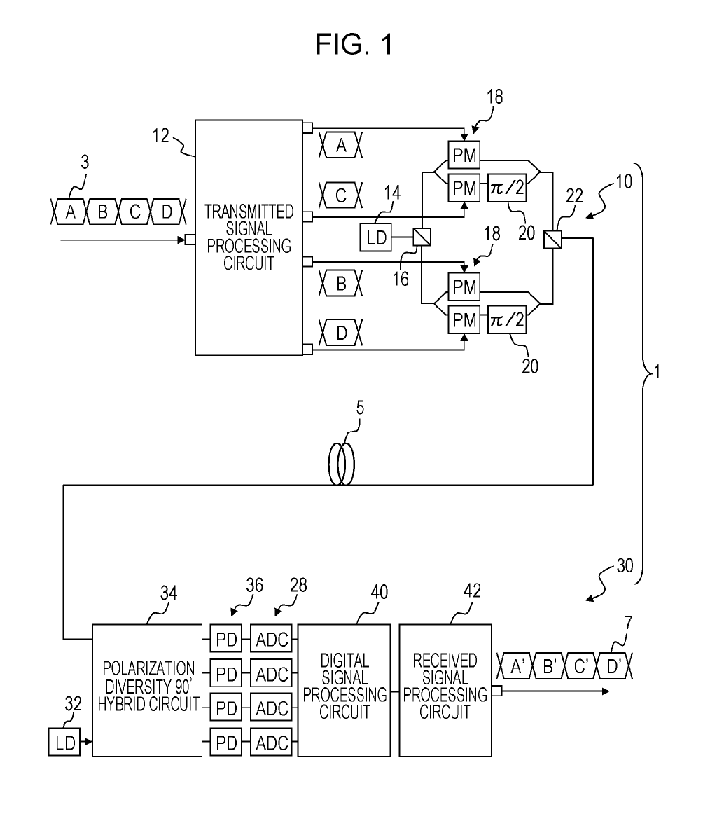

FIG. 1 illustrates an example of configuration of an optical communication system 1 including a digital coherent transmitter and receiver. As illustrated in FIG. 1, the optical communication system 1 is a communication system using Dual Polarization-Quadrature Phase Shift Keying (DP-QPSK) modulation.

The optical communication system 1 includes an optical transmitter 10 and an optical receiver 30, which are connected to each other via a transmission path 5. The optical transmitter 10 includes a transmitted signal processing circuit 12, a light source 14, a polarization demultiplexer 16, a phase modulator (PM) 18, a phase shifter 20, and a multiplexer 22.

In the first embodiment, the transmitted signal processing circuit 12 is a circuit for parallel-developing transmitted data 3 into four rows, for example. The light source 14 is, for example, a semiconductor laser (laser diode (LD)) outputting continuous light of a predetermined wavelength. The polarization demultiplexer 16 is a polarization demultiplexing device for demultiplexing the light output from the light source 14 into polarization components orthogonal to each other. The phase modulator 18 is a circuit for phase-modulating the light from the light source 14 in accordance with an output signal of the transmitted signal processing circuit 12. In the first embodiment, since the DP-QPSK modulation is used, four phase modulators 18 are disposed. The phase shifter 20 is a phase adjuster for shifting each of the orthogonal polarization components through π/2. The multiplexer 22 is a polarization multiplexing device for multiplexing lights input thereto.

The optical receiver 30 includes a local oscillation light source 32, a polarization diversity 90° hybrid circuit (hereinafter referred to as a “polarization diversity circuit”) 34, a photodetector (PD) 36, an Analog-to-Digital (AD) converter (ADC) 38, a digital signal processing circuit 40, and a received signal processing circuit 42. The local oscillation light source 32 is, for example, a semiconductor laser (laser diode (LD)) outputting local oscillation light of the same or substantially the same wavelength as that of the light source 14. The polarization diversity circuit 34 outputs optical signals in accordance with both the optical signal input via the transmission path 5 and the light input from the local oscillation light source 32. More specifically, the polarization diversity circuit 34 outputs an I (In Phase) component optical signal and a Q (Quadrature Phase) component optical signal of a horizontal polarization (called a H polarization), and an I component optical signal and a Q component optical signal of a vertical polarization (called a V polarization).

The photodetector 36 is a detector for detecting the optical signal per output of the polarization diversity circuit 34 and converting the optical signal to an electrical signal. The photodetector 36 is disposed for each signal. The AD converter 38 is a circuit for converting an analog signal input thereto to a digital signal.

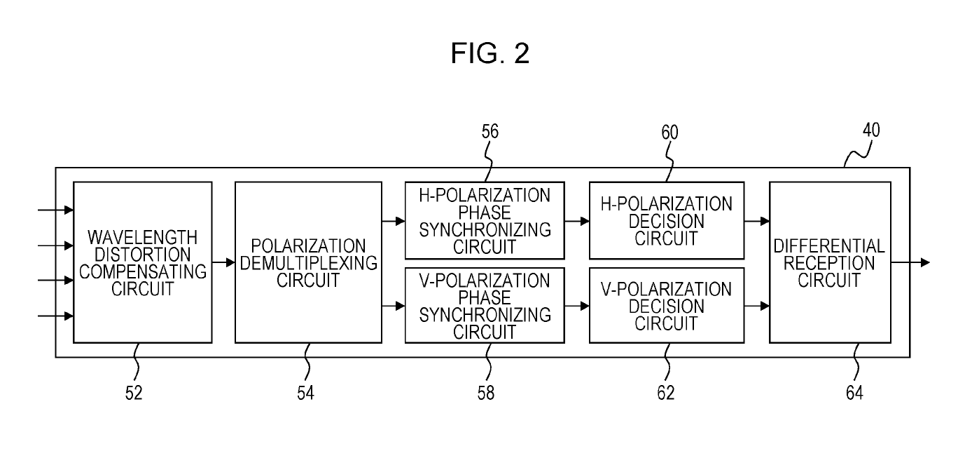

The digital signal processing circuit 40 processes the digital signal representing the optical signal. The processing executed by the digital signal processing circuit 40 will be described later with reference to FIG. 2. The received signal processing circuit 42 is a circuit for processing a signal, which has been processed by the digital signal processing circuit 40, to reproduce the transmitted data 3 having been transmitted from the optical transmitter 10, and for outputting the signal as received data 7.

In the optical communication system 1, the light generated by the light source 14 in the optical transmitter 10 is demultiplexed by the polarization demultiplexer 16 into the polarization components orthogonal to each other. The demultiplexed lights of H polarization and V polarization are each further split into two, and total four lights are respectively applied to the four phase modulators 18. The light input to each phase modulators 18 is phase-modulated in accordance with the transmitted signal having been processed by the transmitted signal processing circuit 12. Furthermore, the phase of one of the paired lights corresponding to each polarization is shifted by the phase shifter 20 through π/2. Thereafter, the four lights are multiplexed by the multiplexer 22. As a result, a 4-bit coded optical signal is transmitted from the optical transmitter 10 to the optical receiver 30 via the transmission path 5.

In the optical receiver 30, the optical signal from the transmission path 5 and the local oscillation light output from the local oscillation light source 32 are applied to the polarization diversity circuit 34. The polarization diversity circuit 34 outputs total four signals, that is, the I and Q components for each of the H polarization and the V polarization. The lights output from the polarization diversity circuit 34 are converted to electrical signals by the photodetectors 36. The converted electrical signals are subjected to AD conversion in the AD converters 38 and are input to the digital signal processing circuit 40. The digital signal processing circuit 40 and the received signal processing circuit 42 execute a 4-bit decoding process on the AD-converted signals.

In the optical communication system 1, as described above, 4-bit information is transmitted between the optical transmitter 10 and the optical receiver 30 in a period of one symbol time. In FIG. 1, the 4-bit transmitted data 3 coded by the optical transmitter 10 are denoted by A, B, C and D, and 4-bit received data 7 reproduced by the optical receiver 30 are denoted by A′, B′, C′ and D′.

FIG. 2 illustrates an example of configuration of the digital signal processing circuit 40. The digital signal processing circuit 40 includes a wavelength distortion compensating circuit 52, a polarization demultiplexing circuit 54, a H-polarization phase synchronizing circuit 56, a V-polarization phase synchronizing circuit 58, a H-polarization decision circuit 60, a V-polarization decision circuit 62, and a differential reception circuit 64.

The wavelength distortion compensating circuit 52 is a circuit for compensating for a wavelength distortion of each signal, which occurs in the transmission path 5, for example. The polarization demultiplexing circuit 54 is a circuit for executing the polarization demultiplexing of the received signals based on the signals having been optically demultiplexed by the polarization diversity circuit 34 while reducing the influences of polarization rotation, Polarization Mode Dispersion (PMD), and so on.

The H-polarization phase synchronizing circuit 56 and the V-polarization phase synchronizing circuit 58 are each a circuit for executing phase synchronization on two signals having been subjected to the polarization demultiplexing in the polarization demultiplexing circuit 54. The H-polarization decision circuit 60 and the V-polarization decision circuit 62 are circuits for deciding signals based on the output signals of the H-polarization phase synchronizing circuit 56 and the V-polarization phase synchronizing circuit 58, respectively. The differential reception circuit 64 is a circuit for generating one demodulated (decoded) data signal based on outputs of the H-polarization decision circuit 60 and the V-polarization decision circuit 62.

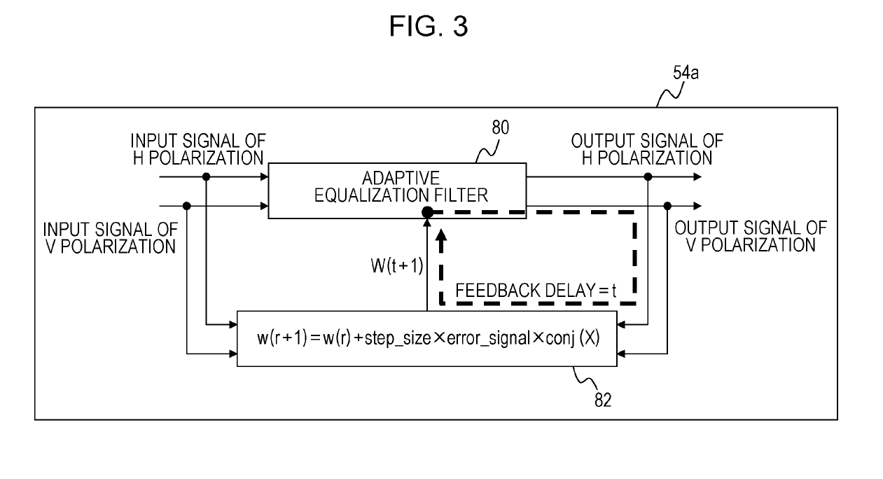

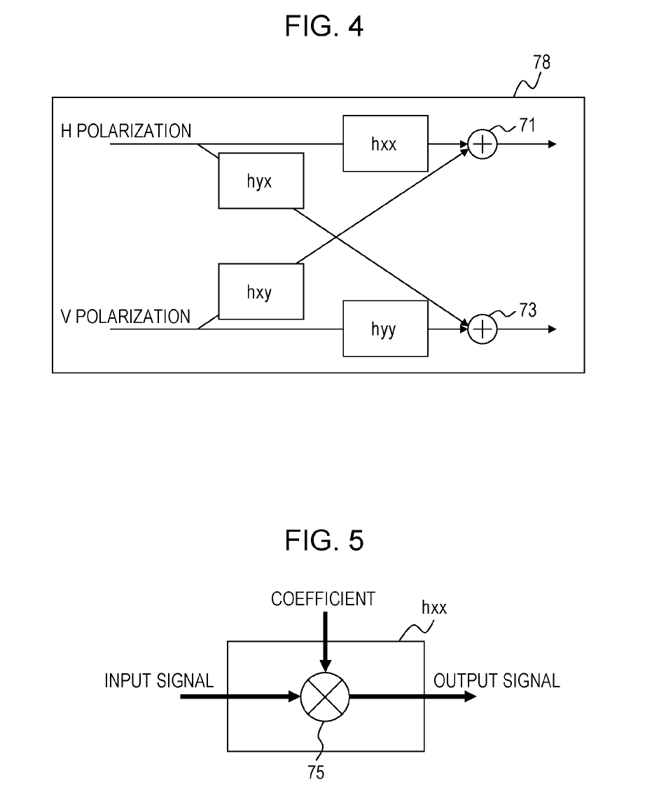

An example of configuration of the polarization demultiplexing circuit 54 will be described below with reference to FIGS. 3, 4 and 5. FIG. 3 illustrates, as one example of the polarization demultiplexing circuit 54 in FIG. 2, a polarization demultiplexing circuit 54a including an adaptive equalization filter 80 and a coefficient calculation circuit 82. FIG. 4 illustrates an example of configuration of the adaptive equalization filter 80. FIG. 5 illustrates an example of configuration of a FIR filter.

As illustrated in FIG. 3, the adaptive equalization filter 80 is, for example, a computing circuit for receiving input signals of H polarization and V polarization, executing predetermined computations, and outputting output signals of H polarization and V polarization, which have been subjected to the polarization demultiplexing.

As illustrated in FIG. 4, a butterfly-type filter 78 may be used as one example of the adaptive equalization filter 80. The butterfly-type filter 78 is a filter made of 2×2 butterfly matrix, for example, which is employed in the polarization demultiplexing to obtain two output signals from two input signals. The butterfly-type filter 78 includes four FIR filters hxx, hyx, hxy and hyy, and two adders 71 and 73. The adder 71 is connected to the FIR filter hxx and the FIR filter hxy, and the adder 73 is connected to the FIR filter hyx and the FIR filter hyy.

In the butterfly-type filter 78, for example, the H polarization is input to the FIR filters hxx and hyx, and the V polarization is input to the FIR filters hxy and hyy. The adder 71 adds output signals of the FIR filters hxx and hyx and outputs a sum signal. The adder 73 adds output signals of the FIR filters hxy and hyy and outputs a sum signal. Thus, two output signals are obtained from two input signals through the polarization demultiplexing.

As illustrated in FIG. 5, the FIR filter hxx included in the butterfly-type filter 78 of FIG. 4 may be constituted, for example, as a multiplier 75. An input signal and a coefficient are input to the multiplier 75. The input signal is multiplied by the coefficient, and a multiplication result is output, as an output signal, from the multiplier 75. The other FIR filters hyx, hxy and hyy in the butterfly-type filter 78 may also be constituted in similar way. It is to be noted that only the FIR filter hxx, illustrated in FIG. 5, may be included in the adaptive equalization filter 80. In such a case, the coefficient calculation circuit 82 calculates one coefficient w(r+1) per calculation.

Returning to FIG. 3, the adaptive equalization filter 80 employs some method for detecting and controlling an optimum polarization state in order to follow polarization variations that occur in the transmission path 5, for example. To that end, the coefficient calculation circuit 82 is disposed in the example of FIG. 3.

The coefficient calculation circuit 82 is a circuit for updating the filter coefficient used in computation executed in the adaptive equalization filter 80 in accordance with the difference between a value of the output signal of the adaptive equalization filter 80 and an objective value. For example, the CMA method, the MMA method, the RDE method, and so on, discussed in the above-mentioned Japanese Laid-open Patent Publication No. 2009-296596 and three papers, may be applied to the coefficient calculation circuit 82.

For example, the CMA method updates a tap coefficient of an adaptive equalization filter such that an amplitude modulation component of an output signal is zero. The CMA method is featured in that it is highly flexible because of applicability to even a state where a wavelength is deteriorated to a large extent, and that it is easily installed because of having a simple algorithm. Therefore, the CMA method has been most widely employed so far as a polarization demultiplexing method in the polarization multiplexing QPSK modulation system. Various polarization demultiplexing methods have also been widely studied for a multi-value signal with amplitude modulation such as 16 Quadrature Amplitude Modulation (QAM). MMA and RDE, which are enhanced version of CMA, are proposed as typical methods.

The first embodiment represents the case in which the coefficient calculation circuit 82 employs the CMA method in calculating the coefficient and updates the coefficient based on the following formula (1);

w(r+1)=w(r)+step_size×Error_signal×conj(X) (1)

where r denotes a variable related to the number of times of update, w(r) denotes (a set of) current filter coefficients (hereinafter collectively referred to as a “current filter coefficient”), and w(r+1) denotes a next filter coefficient. Furthermore, step_size denotes an adjustment coefficient, Error_signal denotes a difference between an expected amplitude and a current amplitude of an output signal, and conj(X) denotes a complex conjugate of an input.

For example, when the configuration of the FIR filter hxx illustrated in FIG. 5 is applied to all the FIR filters hxx, hyx, hxy and hyy in FIG. 4, four kinds of coefficients are used in the butterfly-type filter 78. In that case, the coefficients w(r) and w(r+1) are each calculated as one set of four coefficients.

Thus, update of the coefficient is performed in all the filters included in each adaptive equalization filter 80. Moreover, when the above-described signal processing units are actually incorporated in an integrated circuit, a calculation delay occurs until the coefficient calculation circuit 82 finishes the calculation for optimizing the filter coefficient and the calculation result is fed back to the adaptive equalization filter 80. The calculation delay is caused by circuit restrictions imposed when incorporating the adaptive equalization filter 80, the coefficient calculation circuit 82, and so on. Such a delay is called a “feedback delay” hereinafter. In the example of FIG. 3, as denoted by a broken-line arrow, a feedback delay t occurs until the coefficient of the adaptive equalization filter 80 is updated by the coefficient calculation circuit 82.

The above-described polarization demultiplexing circuit 54 is incorporated plural in a parallel developed form due to restrictions imposed when incorporating the circuits. For example, when signals input at 10 Gbps are input to a Large Scale Integrated (LSI) circuit incorporating one polarization demultiplexing circuit 54, it is difficult to process those signals with the current technology. Therefore, the processing is enabled by distributing the signals per 100 Mbps, for example, to 100 polarization demultiplexing circuits in the parallel developed form.

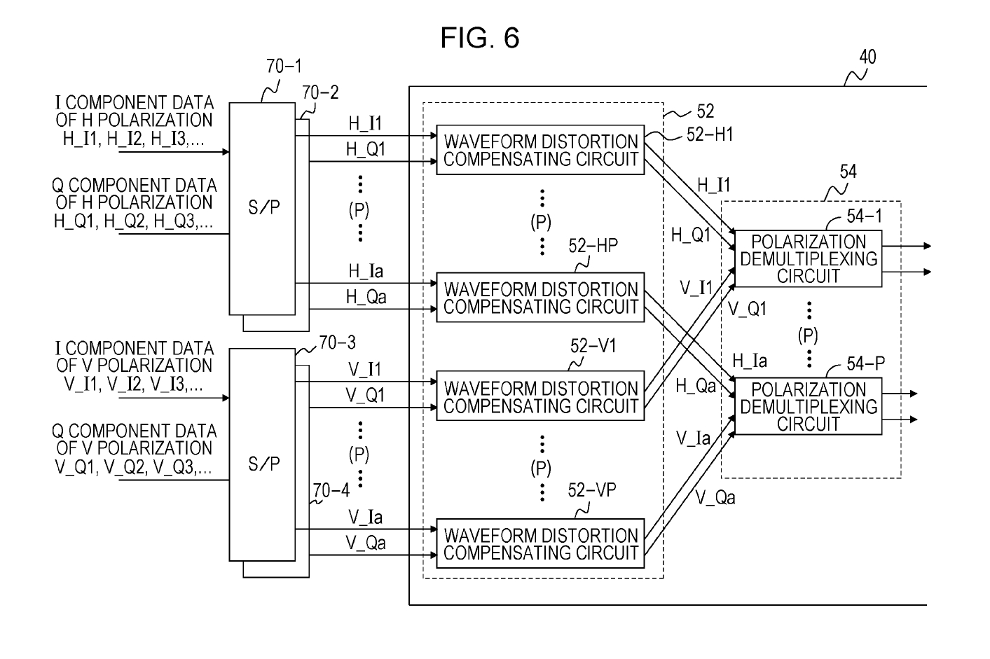

FIG. 6 illustrates an example of configuration of a Serial Parallel conversion circuit (hereinafter denoted by “S/P”) and the digital signal processing circuit 40 according to the first embodiment. To distribute and input the signals in the parallel developed form to the digital signal processing circuit 40 as described above, S/P 70-1 to 70-4 (hereinafter collectively or representatively referred to also as “S/P 70”) are provided as illustrated in FIG. 6. The S/P 70 is disposed between the AD converter 38 and the digital signal processing circuit 40 illustrated in FIGS. 1 and 2.

In the example of FIG. 6, four S/Ps 70 are disposed, and four signals from the AD converters 38 are input to the four S/Ps 70, respectively. The four signals correspond to the I and Q components (H_I, H_Q, V_I and V_Q) for each of the H polarization and the V polarization. The digital signal processing circuit 40 includes waveform distortion compensating circuits 52-H1 to 52-HP (P denotes the number of parallel developed circuits and is an integer satisfying P≧2), waveform distortion compensating circuits 52-V1 to 52-VP, the polarization demultiplexing circuits 54-1 to 54-P, and so on.

The S/P 70 is a circuit for parallel-developing a serial signal into P signals and outputting the P signals. In the example of FIG. 6, the S/P 70-1 is a circuit for receiving the I component of the H polarization and outputting, for example, a number P of parallel developed signals from the I component of the H polarization. Similarly, the S/P 70-2, the S/P 70-3, and the S/P 70-4 are circuits for receiving the Q component of the H polarization, the I component of the V polarization, and the Q component of the V polarization, respectively, each of those circuits outputting a number P of parallel developed signals from the corresponding component.

The waveform distortion compensating circuits 52-H1 to 52-HP are circuits for compensating for waveform distortions of the I and Q components of the H polarization, which have been parallel-developed into the P signals. The waveform distortion compensating circuits 52-V1 to 52-VP are circuits for compensating for waveform distortions of the I and Q components of the V polarization, which have been parallel-developed into the P signals. The polarization demultiplexing circuits 54-1 to 54-P are circuits for executing the polarization demultiplexing of the H polarization and the V polarization, which are each parallel-developed into the P signals.

The operations of the circuits illustrated in FIG. 6 will be described below. The S/P 70-1 and 70-2 output signals of the I and Q components of the H polarization, which are input thereto, after parallel-developing respective input signals into P signals. Output signals H_Ip and H_Qp (p is an integer satisfying 1≦p≦P) are input to the waveform distortion compensating circuits 52-Hp, respectively. The S/P 70-3 and 70-4 output signals of the I and Q components of the V polarization, which are input thereto, after parallel-developing respective input signals into P signals. Output signals V_Ip and V_Qp are input to the waveform distortion compensating circuits 52-Vp, respectively. The signals H_Ip, H_Qp, V_Ip and V_Qp are input to the polarization demultiplexing circuits 54-p, respectively, which outputs H polarization signals and V polarization signals having been subjected to the polarization demultiplexing. Accordingly, the H polarization signals and the V polarization signals parallel-developed into P signals per polarization are output from the polarization demultiplexing circuit 54.

In the polarization demultiplexing circuit 54, the adaptive equalization filter 80, such as the butterfly-type filter 78, may execute computation of multiplying the input signal by the filter coefficient per clock. To that end, the adaptive equalization filter 80 is incorporated for each of all lanes of the polarization demultiplexing circuits 54 in the parallel developed form.

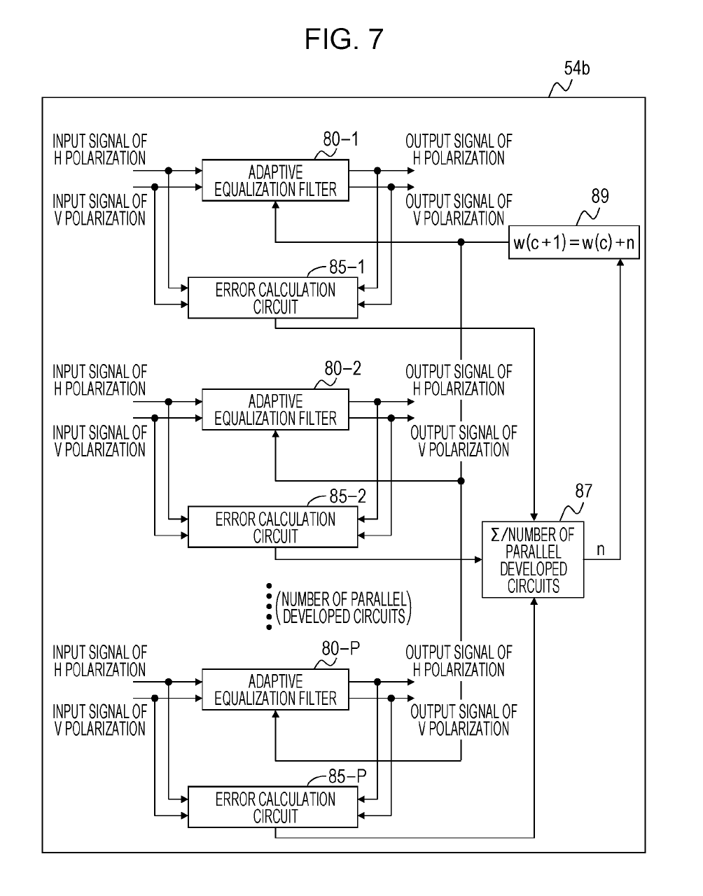

FIG. 7 illustrates a polarization demultiplexing circuit 54b as a comparative example. In the polarization demultiplexing circuit 54b, the adaptive equalization filter 80 and the coefficient calculation circuit 82 are incorporated for each of all lanes of the polarization demultiplexing circuits 54. More specifically, the polarization demultiplexing circuit 54b includes a number P of adaptive equalization filters 80-1 to 80-P (collectively also called “adaptive equalization filters 80-p”), and a number P of error calculation circuits 85-1 to 85-P (collectively also called “error calculation circuits 85-P”), one averaging circuit 87, and a coefficient update circuit 89.

In the polarization demultiplexing circuit 54b, the error calculation circuits 85-p receive input signals applied to the adaptive equalization filters 80-p and output signals of the adaptive equalization filters 80-p, respectively. All the error calculation circuits 85-p are connected to the averaging circuit 87, and the averaging circuit 87 is connected to the coefficient update circuit 89.

Herein, each error calculation circuit 85 is a circuit for calculating an error signal Es(p) per lane. The error signal Es(p) is expressed by the following formula (2);

Es(p)=step_size×Error_signal(p)×conj(X) (2)

where step_size denotes an adjustment coefficient, Error_signal(p) denotes a difference between an expected amplitude and a current amplitude of the output signal of the adaptive equalization filter 80-p, and conj(X) denotes a complex conjugate of the output.

The averaging circuit 87 is a circuit for taking the sum of all the calculated error signals Es(p) and averaging the sum, thereby calculating an average signal Eav. Herein, Eav is expressed by the following formula (3):

Eav=(Es(1)+ . . . +Es(P))/P (3)

The coefficient update circuit 89 is a circuit for calculating a coefficient (for the next update denoted by (r+1)) based on the average signal Eav, and feeding back the calculated coefficient to the adaptive equalization filter 80. On that occasion, the next coefficient w(r+1) is expressed by the following formula (4) using the current coefficient w(r);

w(r+1)=w(r)+Eav (4)

where r denotes a variable related to the number of times the coefficient is updated.

In some cases, the error calculation circuits 85 in FIG. 7 are incorporated in reduced number. Namely, the error calculation circuits 85 are often incorporated in only one or several of all the lanes. In that case, one error calculation circuit 85 may be incorporated for plural lanes, and a thinning process may be executed such that, for the adaptive equalization filter 80 not including the error calculation circuit 85, the computation for updating the coefficient based on an output signal of the relevant adaptive equalization filter 80 is not performed. When employing the CMA method or the like, if the thinning process is executed, there may generate a phenomenon that polarization demultiplexing performance degrades, or that update of the coefficient does not follow polarization rotation, or that characteristics degrade as compared with noise. It is, therefore, generally desirable that the error calculation circuit 85 is incorporated in as many as possible lanes.

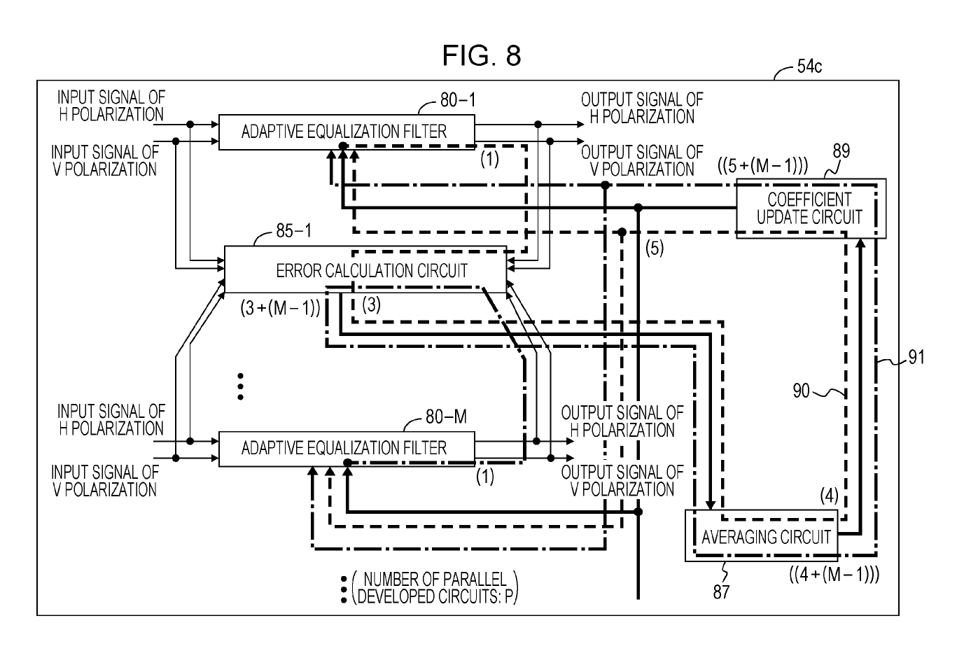

FIG. 8 illustrates the configuration and the processing operation of a polarization demultiplexing circuit 54c. The polarization demultiplexing circuit 54c includes one error calculation circuit 85 for plural adaptive equalization filters 80. As illustrated in FIG. 8, the polarization demultiplexing circuit 54c includes a number P of adaptive equalization filters 80-p (p is an integer satisfying 1≦p≦P) corresponding to the number of parallel developed signals. Moreover, the polarization demultiplexing circuit 54c includes an error calculation circuit 85, an averaging circuit 87, and a coefficient update circuit 89. The error calculation circuit 85 is provided one for the adaptive equalization filters 80-p in a sharing number M (M is an aliquot of P). The number of error calculation circuits incorporated is given by P/M=N (N is an aliquot of P). The operation of the polarization demultiplexing circuit 54c according to the first embodiment will be described later.

In the following description, corresponding to the shared error calculation circuit 85-n (n is an integer satisfying 1≦n≦P/M), the adaptive equalization filter 80-p is also called an adaptive equalization filter 80-n(α) (α is an integer satisfying 1≦α≦M).

In the polarization demultiplexing circuit 54c, each error calculation circuit 85-n receives an input signal applied to the adaptive equalization filter 80-n(α) and an output signal of the adaptive equalization filter 80-n(α). All the error calculation circuits 85-n are connected to the averaging circuit 87, and the averaging circuit 87 is connected to the coefficient update circuit 89. The operation of the polarization demultiplexing circuit 54c according to the first embodiment is described below.

First, a thinning process is described in connection with the case where the signal processing method according to the first embodiment is not employed in the polarization demultiplexing circuit 54c. The error calculation circuit 85-1 is provided for a number M of adaptive equalization filters 80-1(1) to 80-1(M), and it calculates the error signal Es(1) based on an output signal of the adaptive equalization filter 80-1(1), for example, in the thinning process. Similarly, each of the other error calculation circuits 85 in a number ((P/M)−1) calculates the error signal Es(n) based on an output signal of the corresponding adaptive equalization filter 80-n(1), for example. The output signal used in calculating the error signal Es(n) may be another one among the number M of adaptive equalization filters 80-n(1) to 80-n(M).

The (error signal) averaging circuit 87 sums up a number (P/M) of error signals Es calculated by the number (P/M) of error calculation circuits 85-n and averages the sum, thereby calculating an average signal Eav. The average signal Eav in this case is expressed by the following formula (5):

Eav=(Es(1)+ . . . +Es(P/M))/(P/M) (5)

The coefficient update circuit 89 updates the next coefficient of each adaptive equalization filter 80-p based on the average signal Eav, which has been calculated by the averaging circuit 87, using the above formula (4).

Assume here that the number of error signals Es(n) averaged for updating the coefficient is called an averaging number L. In the example of FIG. 7, the averaging number L is given by L=P/M. In this case, when a delay taken for feedback to update the coefficient is defined as the feedback delay t, an update interval is given by the time t regardless of respective values of the number P of parallel developed signals and the averaging number L.

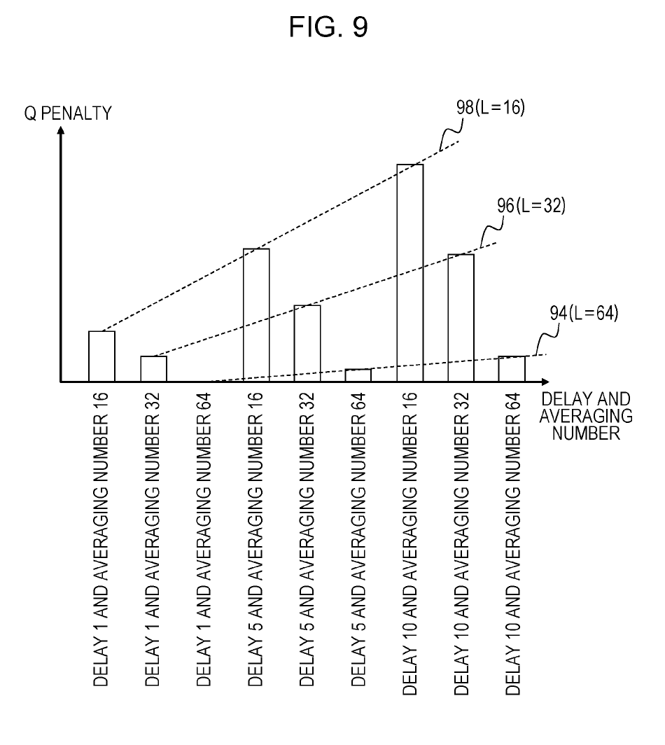

FIG. 9 illustrates the result of calculating quality of the output signal while the feedback delay t and the averaging number L are changed, when the coefficient is updated through the above-described thinning process. In FIG. 9, the signal quality is illustrated as Q penalty with respect to total nine combinations of the feedback delay t=1, 5 and 10 and the averaging number L=16, 32 and 64 on condition that the RDE method is used and the number P of parallel developed signals is set to P=64.

The term “Q penalty” implies a value representing degradation of a signal. Herein, the Q penalty is indicated on the basis of a Q value=Q0 (Q penalty=0) that represents the signal quality on conditions of the feedback delay t=1 and the averaging number L=64. A smaller value of the Q penalty indicates better signal quality. A Q value=Q under certain conditions is expressed by the following formula (6);

$$BER = \frac{1}{2} erfc \frac{Q}{\sqrt{2}} \qquad ( 6 )$$

where BER denotes a bit error rate. Thus, the Q penalty=Qp is expressed by the following formula (7):

Qp=Q−Q0 (7)

In FIG. 9, the vertical axis represents the Q penalty, and the horizontal axis represents the feedback delay t and the averaging number L. As illustrated in FIG. 9, the Q penalty increases as the feedback delay t increases and the averaging number L decreases. Furthermore, as indicated by linear lines 94 to 98, a gradient of the linear line apparently increases as the averaging number L decreases in order of 64, 32 and 16 in spite of that the feedback delay t changes in order of 1, 5 and 10 in a similar manner. Such a result implies that, under the conditions set in the case of FIG. 9, the averaging number L gives a greater influence on the Q penalty than the feedback delay t.

As discussed above, when the averaging number L is a large value near the number P of parallel developed signals, the Q penalty is not so affected by the feedback delay t. In the first embodiment, the polarization demultiplexing circuit 54 is constituted by utilizing such a feature. In other words, when the error calculation circuit 85 is not incorporated in each of all lanes of the adaptive equalization filters 80, one error calculation circuit 85 is shared by plural adaptive equalization filters 80. Furthermore, the error signals are calculated for the predetermined adaptive equalization filters 80-p and are averaged by the averaging circuit 87, thereby calculating the coefficient updated by the coefficient update circuit 89. Thus, it is expected that the Q value and the performance in following polarization variations are improved in comparison with the related art.

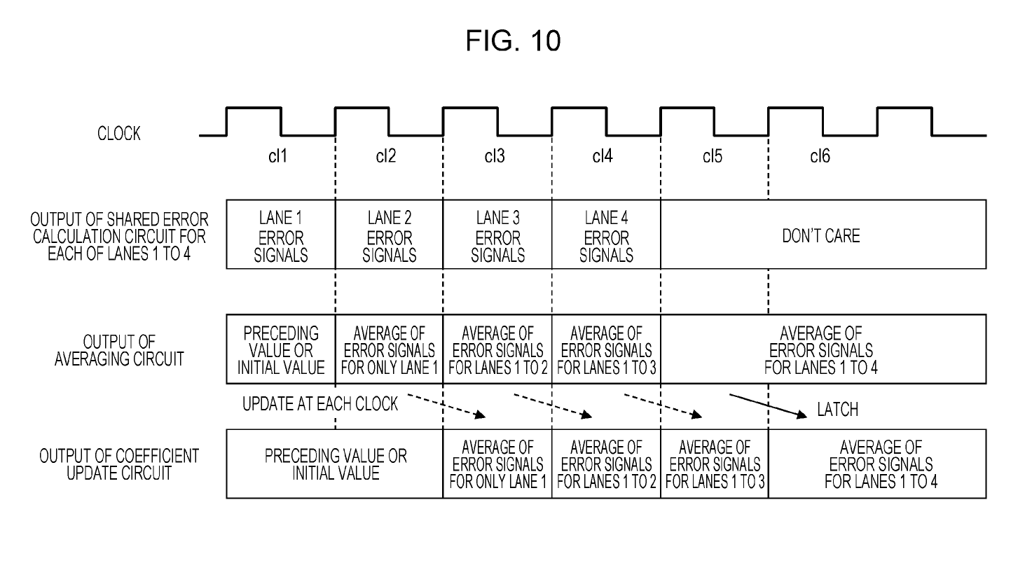

The operation of the polarization demultiplexing circuit 54c according to the first embodiment will be described below with reference to FIGS. 8 and 10. FIG. 10 is a time chart for a signal processing method when one error calculation circuit 85 is shared by plural adaptive equalization filters 80. In the polarization demultiplexing circuit 54c according to the first embodiment, the error calculation circuit 85 is disposed in smaller number than the adaptive equalization filters 80, and the error signal is calculated from output signals of plural adaptive equalization filters 80 by sharing the one error calculation circuit 85. A method of sharing the error calculation circuit 85 in the first embodiment is time division.

In FIG. 8, arrows 90 and 91 indicate flows of coefficient update. In the example of FIG. 8, a processing time in each circuit is 1 clock, and a processing time in only the error calculation circuit 85 is 2 clocks. Moreover, the number of processing clocks taken until reaching the relevant point is denoted, as an example, in an associated parenthesis.

In the polarization demultiplexing circuit 54c, as described above, one error calculation circuit 85 is shared by the adaptive equalization filters 80 in the sharing number M. More specifically, as denoted by the arrow 90 in a broken line, the adaptive equalization filter 80-1 first outputs an output signal in accordance with a predetermined coefficient W(1). A time taken until outputting the output signal is assumed to be 1 clock as denoted by (1) under the arrow 90.

Next, the error calculation circuit 85-1 calculates the error signal Es based on the output signal. Herein, the adaptive equalization filter 80-n(α) (α is an integer satisfying 1≦α≦M and n is an integer satisfying 1≦n≦P/M)) represents one of the adaptive equalization filters 80 sharing the error calculation circuit 85-n. The error signal calculated by the error calculation circuit 85-n based on the output signal of the adaptive equalization filter 80-n(α) is denoted by the error signal Es(n(α)). The error signal Es(n(α)) is calculated by the following formula (8);

Es(n(α))=step_size×Error_signal(n(α))×conj(X) (8)

where step_size denotes an adjustment coefficient, Error_signal(n(α)) denotes a difference between an expected amplitude and a current amplitude of the output signal of the adaptive equalization filter 80-n(α), and conj(X) denotes a complex conjugate of an input.

The error calculation circuit 85-1 takes 2 clocks to calculate the error signal Es(1(1)). As a result, the error signal Es(1(1)) is output at the third clock as denoted by (3) aside the arrow 90. Similarly, the error calculation circuit 85-n takes 2 clocks to calculate the error signal Es(n(1)). As a result, the error signal Es(n(1)) is output at the third clock as denoted by (3) aside the arrow 90.

The averaging circuit 87 sums up and averages the error signals Es(n(1)) calculated by the individual error calculation circuits 85-n. First, the averaging circuit 87 obtains the error signal Es(1(1)) output from the error calculation circuit 85-1, and the error signals Es(n(1)) output from the other error calculation circuits 85 in a number ((P/M)−1). An average signal Eav(1) is expressed using those error signals by the following formula (9):

Eav(1)=(Es(1(1))+ . . . +Es(P/M(1))/(P/M) (9)

The averaging circuit 87 outputs the average signal Eav(1) at the fourth clock (as denoted by (4) above the arrow 90 in FIG. 8).

The coefficient update circuit 89 calculates a new (next) coefficient by adding the average signal Eav(1) output from the averaging circuit 87 to the current coefficient, and updates the coefficient for all the adaptive equalization filters 80-p. The next coefficient is expressed by the following formula (10):

w(2)=w(1)+Eav(1) (10)

Until updating the coefficient, 5 clocks are taken as denoted by (5) under the arrow 90. Thus, the feedback delay t=5 is given in the example of FIG. 8.

During a period partly overlapping with the above-described process, the following process is executed based on output signals of the other adaptive equalization filters 80-n(2) sharing respectively the error calculation circuits 85-n. For example, with a delay of 1 clock after the processing related to the adaptive equalization filters 80-n(1), the error signals Es(n(2)) are calculated respectively by the error calculation circuits 85-n based on output signals of the adaptive equalization filters 80-n(2). The averaging circuit 87 sums the error signals Es(n(1)) calculated 1 clock before and the error signals Es(n(2)), and averages the total sum, thereby calculating an average signal Eav(1 to 2). The coefficient update circuit 89 adds the average signal Eav(1 to 2), averaged by the averaging circuit 87, to the current coefficient, thereby calculating a new (next) coefficient and updating the coefficient for all the adaptive equalization filters 80.

Similarly, an average of the error signals Es(n(1)) to Es(n(α)) calculated based on the output signals of the first to α-th adaptive equalization filters 80-n(1) to 80-n(α) among the sharing number M of adaptive equalization filters 80 is called an average signal Eav(1 to α). The average signal Eav(1) represents the average signal at α=1. The average signal Eav(1 to α) is expressed by the following formula (11):

Eav(1 to α)=[{Es(1(1))+ . . . +Es(P/M(1))}+ . . . +{Es(a(1))+ . . . +Es(α(P/M))}]/(P/M) (11)

In that case, the next coefficient w(r+1) is expressed by the following formula (12):

w(r+1)=w(r)+Eav(1 to α) (12)

Similarly, with a delay of (M−1) clocks after the calculation of the error signals Es(n(1)) by the error calculation circuits 85-n, the following process is executed based on output signals of the other adaptive equalization filters 80-n(M) sharing respectively the error calculation circuits 85-n. As one example, the process executed by the error calculation circuit 85-1 is represented by the arrow 91 in a one-dot-chain line.

In more detail, with a delay of (M−1) clocks after the process of calculating the error signals Es(n(1)), the error calculation circuits 85-n calculate the error signals Es(n(M)) based on output signals of the adaptive equalization filters 80-n(M). At that time, (3+(M−1)) clocks are lapsed from the start of the processing executed by the adaptive equalization filter 80-1 as denoted, for example, on the left side of the arrow 91 near the error calculation circuit 85-1 in FIG. 8.

The averaging circuit 87 sums the error signals Es(n(1)) calculated 1 clock before and the error signals Es(n(M)), and averages the total sum, thereby calculating an average signal Eav(1 to M). At that time, (4+(M−1)) clocks are lapsed as denoted under the arrow 91 near the averaging circuit 87.

The coefficient update circuit 89 adds the average signal Eav(1 to M), averaged by the averaging circuit 87, to the current coefficient, thereby calculating a new coefficient and updating the coefficient for all the adaptive equalization filters 80-p. More specifically, the coefficient update circuit 89 updates the coefficient of each adaptive equalization filter 80 with the following formula (13):

w(r+1)=w(r)+Eav(1 to M) (13)

At that time, (5+(M−1)) clocks are lapsed as denoted above the arrow 91 near the coefficient update circuit 89 in FIG. 8.

The foregoing process will be further described with reference to FIG. 10. FIG. 10 represents the case where the sharing number M is four (M=4) and the adaptive equalization filters 80-n(1) to 80-n(4) sharing respective one error calculation circuits 85-n are represented by lane 1 to lane 4. As illustrated in FIG. 10, for example, the error signals calculated based on the output signals of the adaptive equalization filters 80 for each of the lanes 1 to 4, the output signal of the averaging circuit 87, and the output signal of the coefficient update circuit 89 are output in a time division manner with respect to successive clocks.

As the output signals of the error calculation circuits 85-n, the error signals Es(n(1)) based on the output signals in the lane 1 are output at a first clock cl1. Thereafter, the error signals Es(n(2)) to Es(n(4) for the lanes 2 to 4 are successively output per clock until a fourth clock cl4.

As the output signal of the averaging circuit 87, the average signal Eav(1) is calculated at a second clock cl2. The average signal Eav(1) is calculated by averaging the error signals Es(n(1)) obtained by all the error calculation circuits 85-n in the lane 1. An average signal Eav(1 to 2) is calculated at a third clock cl3. The average signal Eav(1 to 2) is calculated by averaging the error signals Es(n(1)) and Es(n(2)) obtained by all the error calculation circuits 85-n in the lanes 1 and 2. Similarly, an average signal Eav(1 to 4) is calculated at a fifth clock cl5. The average signal Eav(1 to 4) is calculated by averaging the error signals Es(n(1 to 4)) obtained by all the error calculation circuits 85-n in all the lanes.

As the output signal of the coefficient update circuit 89, the coefficient is calculated at the third clock cl3 based on the average signal Eav(1) and is updated. Thereafter, the coefficient is similarly updated per clock until the coefficient is updated at a sixth clock cl6 based on the average signal Eav(1 to 4) for all the lanes. After the sixth clock cl6, the update is stopped and the error calculation is repeated again starting from the lane 1. On that occasion, the coefficient is held (latched) until the next update is executed. A period during which the coefficient is held is equal to the feedback delay t.

In the example of FIG. 10, even when the processing executed by the error calculation circuit 85 takes plural clocks, the processing is executed in a pipeline way such that input data is updated per clock. As the number of adaptive equalization filters 80 sharing one error calculation circuit 85 increases, a time waiting for completion of the calculation of the error signals in the error calculation circuit 85 prolongs. When the processing in the error calculation circuit 85 is executed in a pipeline way as described above, a filter-coefficient feedback delay tc in the entire polarization demultiplexing circuit 54c is given by tc=t+(M−1) on an assumption that the number of adaptive equalization filters 80 sharing one error calculation circuit 85 is the sharing number M. Thus, the feedback delay tc is longer than the feedback delay t in one error calculation circuit 85. According to the first embodiment, however, the error signals Es(n(α)) based on all of the number P of adaptive equalization filters 80 are used to update the coefficient per feedback delay tc.

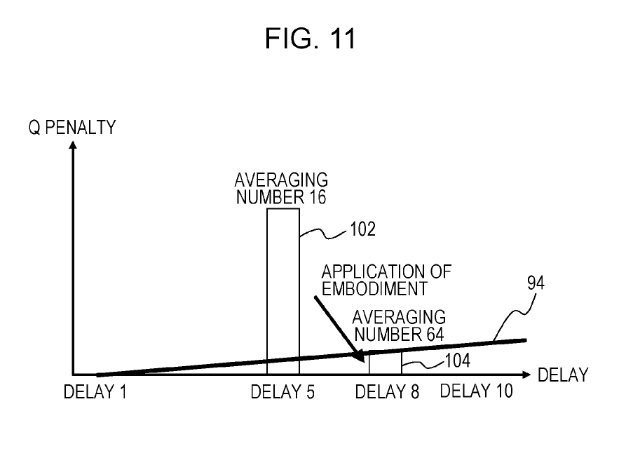

FIG. 11 illustrates the advantageous effect of the signal processing circuit according to the first embodiment. In FIG. 11, the vertical axis represents the Q penalty, and the horizontal axis represents the feedback delay t. A linear line 94 indicates change of the Q penalty with respect to the feedback delay t in the case of the averaging number L=the number P of parallel developed signals=64. Q penalty 102 represents the case of the feedback delay t=5 and the averaging number L=16 when the thinning process is executed as described above. In other words, the Q penalty 102 is obtained with the thinning process executed when one error calculation circuit 85 is provided for the adaptive equalization filters 80 in each of four lanes.

On the other hand, 104 represents the Q penalty of the output signal of the polarization demultiplexing circuit 54c when the processing is executed as illustrated in FIG. 10. In the processing of FIG. 10, as described above, the feedback delay tc is given by tc=t+(M−1)=5+(4−1)=8, but the averaging number L is 64. Thus, the resultant Q penalty corresponds to that obtained at the feedback delay t=8 on the linear line 94. The Q penalty 104 is apparently smaller than the Q penalty 102. This implies that degradation of signal quality is suppressed by employing the time division process in the error calculation circuit 85.

With the polarization demultiplexing circuit 54c according to the first embodiment, as described in detail above, one error calculation circuit 85 is provided for each set of the adaptive equalization filters 80 in the sharing number M. The respective one error calculation circuits 85-n calculate the error signals Es(n(α)) in a time division manner for the number M of adaptive equalization filters 80. The averaging circuit 87 averages the calculated error signals Es(n(α)) per error calculation, thereby calculating the average signal Eav(1 to α). Using the calculated average signal Eav(1 to α), the coefficient update circuit 89 updates the coefficient based on the formula of w(r+1)=w(r)+Eav(1 to α). As a result, the coefficient for all the adaptive equalization filters 80 is updated by the coefficient update circuit 89 at successive clocks during a period from the feedback delay t to tc based on the error signals Es(n(1)) to Es(n(α)) calculated up to that time.

Compare here characteristics between the case using plural adaptive equalization filters 80 just in one lane without sharing the error calculation circuit 85 and the case sharing the error calculation circuit 85 in a time division manner. In the latter case, the feedback delay increases by (M−1) clocks, for example, while the number of adaptive equalization filters 80 used in the averaging process increases by (M−1)×(P/M). It is hence possible to utilize the fact that the effect of reducing degradation of signal quality, which is obtained by increasing the number of adaptive equalization filters 80 used in the averaging process, is more significant than the degradation of signal quality, which is caused by a longer feedback delay.

As a result, signal degradation is suppressed which has been inevitable when one error calculation circuit 85 is disposed for plural adaptive equalization filters 80 and the thinning process is executed. Thus, by sharing the error calculation circuit 85 and increasing the number of error signals used in the averaging circuit 87 to the number P of parallel developed signals at maximum, the Q value is increased and the capability of following to polarization variations is improved.

Also, even when the number of error calculation circuits 85 to be incorporated is reduced due to restrictions taking into account the current technical level of integrated circuits and combined arrangement with other signal processing circuits, degradation of the signal quality is suppressed in a situation where the number of incorporated circuits is reduced. Moreover, even when incorporating the error calculation circuit 85 is allowed for each of all the adaptive equalization filters 80, it is realizable to overcome the problem that the presence of the error calculation circuits 85 may restrict the other signal processing circuits, thus degrading characteristics from ideal ones, and may increase power consumption.

In the optical transmission path, it is difficult to maintain the signal quality in some cases due to great influences of polarization rotation, polarization mode dispersion, and so on. However, objective signal quality is maintained with the polarization demultiplexing circuit 54c according to the first embodiment. Thus, since objective performance is achieved with the smaller number of incorporated error calculation circuits 85, an advantage of securing a space for incorporating other circuits with reduction of a circuit scale is also obtained. When other circuits and so on are not incorporated in the space secured by reducing the number of incorporated error calculation circuits 85, another advantage of saving the power consumption is obtained.

A signal processing circuit according to a first modification will be described below. The first modification is a modification of the first embodiment. The signal processing circuit according to the first modification is used in a system having a similar configuration to that of the optical communication system 1 described above with reference to FIGS. 1 and 2. In the first modification, a polarization demultiplexing circuit 54d is provided, instead of the polarization demultiplexing circuit 54c according to the first embodiment, as the polarization demultiplexing circuit 54 in the optical communication system 1. It is to be noted that similar components to those in the signal processing circuit according to the first embodiment are denoted by the same numerals and duplicate description of those components is omitted.

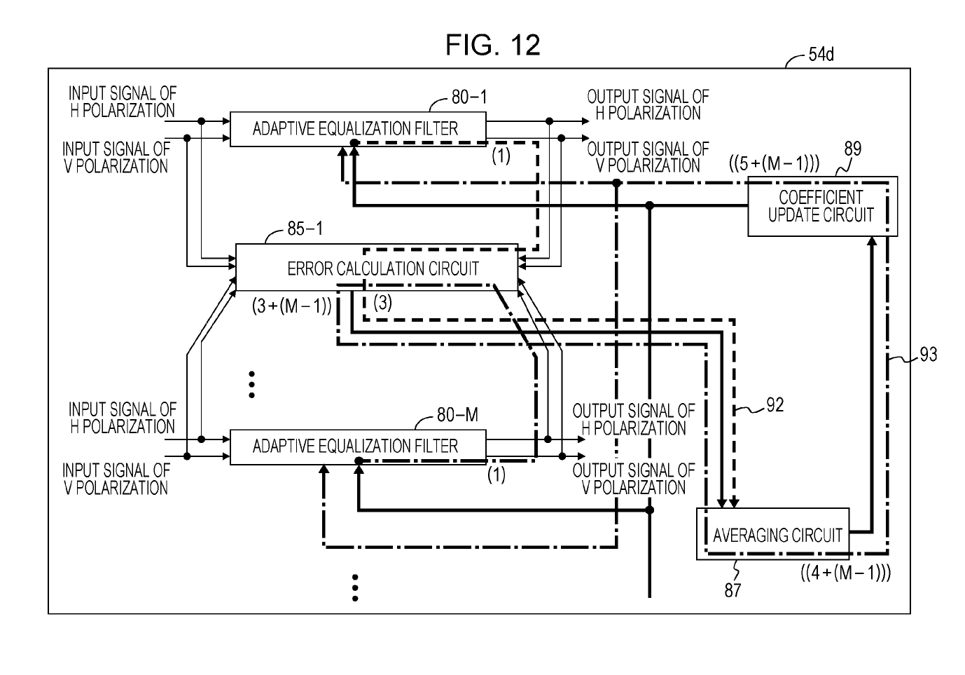

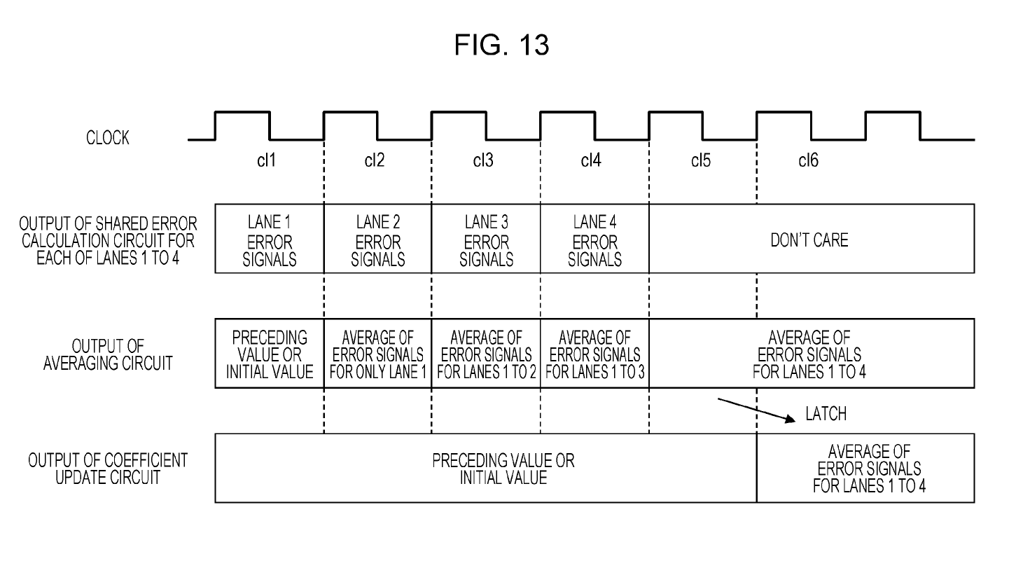

FIG. 12 illustrates the configuration and the processing of the polarization demultiplexing circuit 54d according to the first modification. FIG. 13 is a time chart for a signal processing method according to the first modification. As illustrated in FIG. 12, the configuration of the polarization demultiplexing circuit 54d according to the first modification is similar to that of the polarization demultiplexing circuit 54c. More specifically, the polarization demultiplexing circuit 54d includes the number P of the adaptive equalization filters 80 and the number P/M of error calculation circuits 85. In the polarization demultiplexing circuit 54d, one error calculation circuit 85 is shared by the number M of adaptive equalization filters 80.

In the first modification, corresponding to the shared error calculation circuit 85-n (n is an integer satisfying 1≦n≦P/M), the adaptive equalization filter 80-p is also called an adaptive equalization filter 80-n(α) (α is an integer satisfying 1≦α≦M and n is an integer satisfying 1≦n≦P/M)). Furthermore, the error signal calculated based on the output signal of the adaptive equalization filter 80-n(α) is denoted by the error signal Es(n(α)). The error signal Es(n(α)) is calculated by the above-mentioned formula (8). A method of sharing the error calculation circuits 85-n in the first modification is time division as in the first embodiment.

In FIG. 12, arrows 92 and 93 indicate flows of coefficient update. In the example of FIG. 12, a processing time in each circuit is 1 clock, and a processing time in only the error calculation circuit 85-n is 2 clocks. Moreover, the number of processing clocks taken until reaching the relevant point is denoted, as an example, in an associated parenthesis.

In the polarization demultiplexing circuit 54d, as denoted by the arrow 92 in a broken line, the adaptive equalization filter 80-1 first outputs an output signal in accordance with a predetermined coefficient. A time taken until outputting the output signal is assumed to be 1 clock as denoted by (1) under the arrow 92.

Next, the error calculation circuit 85-1 calculates the error signal Es based on the output signal. The error calculation circuit 85-1 takes 2 clocks to calculate the error signal Es(1(1)). As a result, the error signal Es(1(1)) is output at the third clock as denoted by (3) on the right side of the arrow 92 near the error calculation circuits 85-1 in FIG. 12. Similarly, the error calculation circuit 85-n takes 2 clocks to calculate the error signal Es(n(1)). As a result, the error signal Es(n(1)) is output at the third clock as denoted by (3) aside the arrow 92.

The averaging circuit 87 sums up and averages the error signals Es(n(1)) calculated by the individual error calculation circuits 85-n. At that time, however, the averaging circuit 87 does not output the calculated average signal Eav(1) to the coefficient update circuit 89.

During a period partly overlapping with the above-described process, the following process is executed based on output signals of the other adaptive equalization filters 80-n(2) sharing respectively the error calculation circuits 85-n. For example, with a delay of 1 clock after the processing related to the adaptive equalization filters 80-n(1), the error signals Es(n(2)) are calculated respectively by the error calculation circuits 85-n based on output signals of the adaptive equalization filters 80-n(2).

The averaging circuit 87 sums up the error signals Es(n(2)) calculated by the error calculation circuits 85-n at that time, and averages them together with the already calculated Es(n(1)), thereby calculating an average signal Eav(1 to 2). At that time, however, the averaging circuit 87 does not output the calculated average signal Eav(1 to 2) to the coefficient update circuit 89.

Similarly, with a delay of (α−1) clocks after the calculation of the error signals Es(n(1)) by the error calculation circuits 85-n, the following process is executed based on output signals of the other adaptive equalization filters 80-n(α) sharing respectively the error calculation circuits 85-n. As one example, the process executed by the error calculation circuit 85-1 in the case of α=M is represented by the arrow 93 in a one-dot-chain line in FIG. 12.

As illustrated in FIG. 12, for example, with a delay of (M−1) clocks after the process of calculating the error signals Es(n(1)), the error calculation circuit 85-1 calculates an error signal Es(1(M)) based on an output signal of the adaptive equalization filter 80-1(M). At that time, (3+(M−1)) clocks are lapsed from the start of the processing executed by the adaptive equalization filter 80-1 as denoted, for example, on the left side of the arrow 93 near the error calculation circuit 85-1 in FIG. 12. In the polarization demultiplexing circuit 54d, the above-described process of calculating the error signal Es(n(M)) is executed by all the error calculation circuits 85-n.

The averaging circuit 87 sums up the calculated error signals Es(n(1)) to Es(n(M)) (1≦n≦P/M), and averages the total sum, thereby calculating an average signal Eav(1 to M). The average signal Eav(1 to M) is calculated by putting α=M in the above-mentioned formula (11). At that time, (4+(M−1)) clocks are lapsed as denoted under the arrow 93 near the averaging circuit 87 in FIG. 12. The averaging circuit 87 outputs the average signal Eav(1 to M) to the coefficient update circuit 89.

The coefficient update circuit 89 adds the average signal Eav(1 to M), averaged by the averaging circuit 87, to the current coefficient, thereby calculating a new coefficient w(r+1) and updating the coefficient for all the adaptive equalization filters 80. More specifically, the coefficient update circuit 89 updates the coefficient of each adaptive equalization filter 80 by putting α=M in the above-mentioned formula (12). At that time, (5+(M−1)) clocks are lapsed as denoted above the arrow 93 near the coefficient update circuit 89 in FIG. 12.

The foregoing process will be further described with reference to FIG. 13. FIG. 13 represents the case where the sharing number M is four (M=4) and the adaptive equalization filters 80-n(1) to 80-n(4) sharing respective one error calculation circuits 85-n are represented by lane 1 to lane 4. As illustrated in FIG. 13, for example, the error signals calculated based on the output signals of the adaptive equalization filters 80 for each of the lanes 1 to 4, the output signal of the averaging circuit 87, and the output signal of the coefficient update circuit 89 are output in a time division manner with respect to successive clocks.

As the output signals of the error calculation circuits 85-n, the error signals Es(n(1)) based on the output signals in the lane 1 are output at a first clock cl1. Thereafter, the error signals Es(n(2)) to Es(n(4) for the lanes 2 to 4 are successively output per clock until a fourth clock cl4.

As the output signal of the averaging circuit 87, the average signal Eav(1) is calculated at a second clock cl2 by averaging the error signals Es(n(1)) obtained by all the error calculation circuits 85-n in the lane 1. An average signal Eav(1 to 2) is calculated at a third clock cl3 by averaging the error signals Es(n(1)) and Es(n(2)) obtained by all the error calculation circuits 85-n in the lanes 1 and 2. Similarly, an average signal Eav(1 to 4) is calculated at a fifth clock cl5 by averaging the error signals Es(n(1 to 4)) obtained by all the error calculation circuits 85-n in all the lanes.

As the output signal of the coefficient update circuit 89, the coefficient of the adaptive equalization filters 80 is updated at a sixth clock cl6 based on the average signal Eav(1 to 4) for all the lanes. After the sixth clock cl6, the update is stopped and the error calculation is repeated again starting from the lane 1. On that occasion, the coefficient is held (latched) until the next update is executed. A period during which the coefficient is held is equal to the feedback delay t. Thus, in the first modification, the coefficient update circuit 89 updates the coefficient after the average signal Eav(1-M) has been calculated from the error signals Es(n(α)) based on the output signals of all the adaptive equalization filters 80-n(α).

In the example of FIG. 13, as in the example of FIG. 10, even when the processing executed by the error calculation circuit 85 takes plural clocks, the processing is executed in a pipeline way such that input data is updated per clock. Also in the first modification, as the number of adaptive equalization filters 80 sharing one error calculation circuit 85 increases, a time waiting for completion of the calculation of the error signals in the error calculation circuit 85 prolongs. When the processing in the error calculation circuit 85 is executed in a pipeline way as described above, a filter-coefficient feedback delay tc in the entire polarization demultiplexing circuit 54d is given by tc=t+(M−1) on an assumption that the number of adaptive equalization filters 80 sharing one error calculation circuit 85 is the sharing number M. Thus, the feedback delay tc is longer than the feedback delay t in one error calculation circuit 85. According to the first modification, however, the error signals Es(n(α)) based on all of the number P of adaptive equalization filters 80 are used to update the coefficient per feedback delay tc.

As described above with reference to FIG. 11 in the first embodiment, the Q penalty in the first modification also corresponds to that obtained at the feedback delay t=8 on the linear line 94 similarly to the polarization demultiplexing circuit 54c according to the first embodiment. Therefore, a similar advantage in operation to that in the polarization demultiplexing circuit 54c according to the first embodiment is obtained by executing the time division process in the error calculation circuits 85 in the polarization demultiplexing circuit 54d according to the first modification. Thus, degradation of signal quality is suppressed.

In the following description, the update of the coefficient in the polarization demultiplexing circuit 54c according to the first embodiment is called “each-time update”, and the update of the coefficient according to the first modification is called “latch update”.

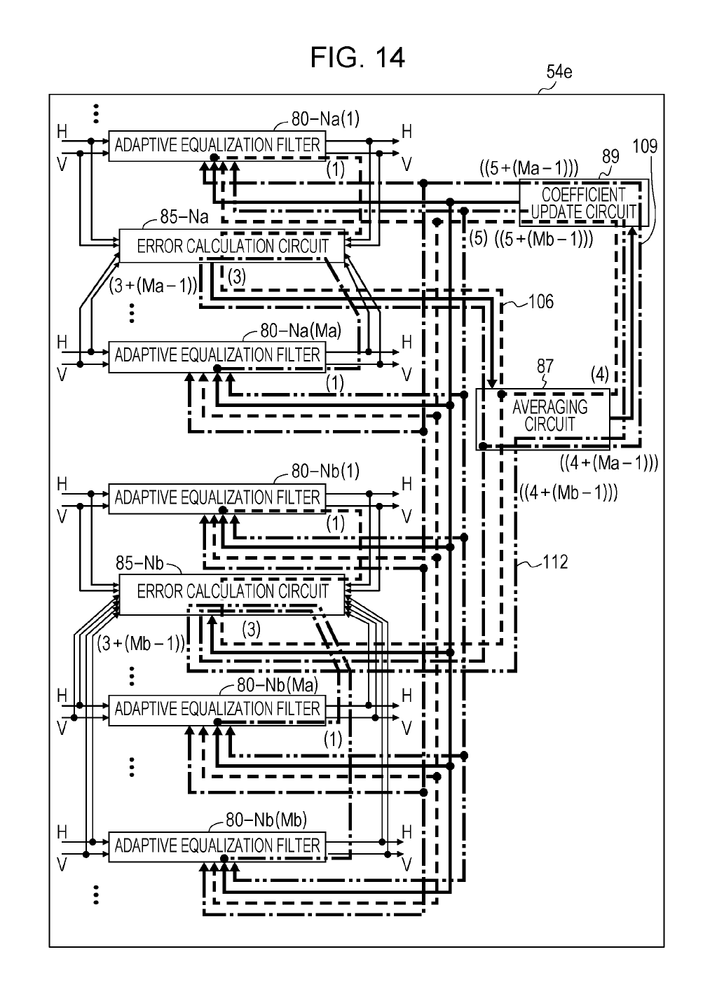

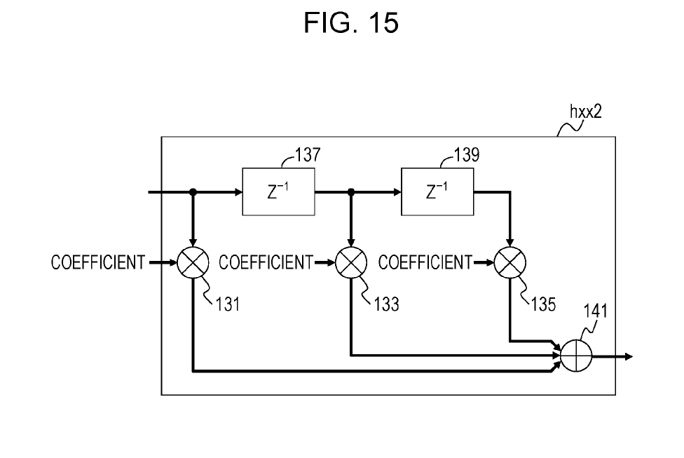

A signal processing circuit according to a second embodiment will be described below with reference to FIG. 14. The signal processing circuit according to the second embodiment is used in a system having a similar configuration to that of the optical communication system 1 described above with reference to FIGS. 1 and 2. In the second embodiment, a polarization demultiplexing circuit 54e is provided as the polarization demultiplexing circuit 54 in the optical communication system 1. It is to be noted that similar components to those in the signal processing circuit according to the first embodiment and the first modification are denoted by the same numerals and duplicate description of those components is omitted.

FIG. 14 illustrates the configuration and the processing of the polarization demultiplexing circuit 54e according to the second embodiment. In the example of FIG. 14, the polarization demultiplexing circuit 54e includes a number P of adaptive equalization filters 80, P being two or more, and a number N of error calculation circuits 85 (N is an integer satisfying 1≦N≦P). In the polarization demultiplexing circuit 54e, one error calculation circuit 85 is employed by one or more adaptive equalization filters 80. Unlike the first embodiment and the first modification, however, the number of adaptive equalization filters 80, denoted by Mn (Mn is an integer satisfying 1≦Mn≦P), sharing one error calculation circuit 85-n (n is an integer satisfying 1≦n≦N) may be different between (or among) the lanes. A method of sharing the error calculation circuits 85 in the second embodiment is time division as in the first embodiment and the first modification.

In the polarization demultiplexing circuit 54e, at n=1, for example, one error calculation circuit 85-1 is shared by the number M1 of not-illustrated adaptive equalization filters 80 (hereinafter referred to as “adaptive equalization filters 80-1(1) to 80-1(M1)”). Thus, the not-illustrated error calculation circuit 85-1 receives input signals applied to the adaptive equalization filters 80-1(1) to 80-1(M1) and output signals thereof, and outputs respective error signals based on those input and output signals in a time division manner.

FIG. 14 illustrates the processing executed in the case of n=Na, Nb (Na and Nb are each an integer of not less than 1 and less than P). Herein, the error calculation circuit 85-Na receives input signals applied to the adaptive equalization filters 80-Na(1) to 80-Na(Ma) in the sharing number Ma and output signals thereof, and outputs respective error signals based on those input and output signals in a time division manner. The error calculation circuit 85-Nb receives input signals applied to the adaptive equalization filters 80-Nb(1) to 80-Nb(Mb) in the sharing number Mb and output signals thereof, and outputs respective error signals based on those input and output signals in a time division manner. It is here assumed that Ma Mb is held, and that the sharing number Mb is a maximum sharing number in the polarization demultiplexing circuit 54e.

In FIG. 14, arrows 106, 109 and 112 indicate flows of coefficient update. In the example of FIG. 14, a processing time in each circuit is 1 clock, and a processing time in only the error calculation circuit 85 is 2 clocks. Moreover, the number of processing clocks taken until reaching the relevant point is denoted, as an example, in an associated parenthesis.

In the polarization demultiplexing circuit 54e, as denoted by the arrow 106 in a broken line, the adaptive equalization filter 80-Na(1) outputs an output signal in accordance with a predetermined coefficient. A time taken until outputting the output signal is assumed to be 1 clock as denoted by (1) under the arrow 106.

Next, the error calculation circuit 85-Na calculates an error signal Es(Na(1)) based on the output signal of the adaptive equalization filter 80-Na(1). The error calculation circuit 85-Na is shared by the adaptive equalization filters 80-Na(ma) (ma is an integer satisfying 1≦ma≦Ma). The error signal calculated based on the output signal of each adaptive equalization filter 80-Na(ma) is denoted by an error signal Es(Na(ma)). The error signal Es(Na(ma)) is calculated by the putting n=Na and α=ma in the formula (8) expressing the error signal Es(n(α)).

On that occasion, the error calculation circuit 85-Na(1) takes 2 clocks to calculate the error signal Es(Na(1)). As a result, the error signal Es(Na(1)) is output at the third clock as denoted by (3) on the right side of the arrow 106 near the error calculation circuits 85-Na in FIG. 14.

The error calculation circuit 85-Nb(1) takes 2 clocks to calculate the error signal Es(Nb(1)). As a result, the error signal Es(Nb(1)) is output at the third clock as denoted by (3) on the right side of the broken-line arrow 106 near the error calculation circuits 85-Nb in FIG. 14. Similarly, at each of all values of n, the error calculation circuit 85-n(1) takes 2 clocks to calculate the error signal Es(n(1)), and the error signal Es(n(1)) is output at the third clock.

The averaging circuit 87 sums up and averages all the error signals Es(1(1)) to Es(N (1)), including Es(Na(1)) and Es(Nb(1), calculated by the error calculation circuits 85-n based on the output signals of the adaptive equalization filters 80-n(1), thereby calculating an average signal Eav(1). At that time, 4 clocks are lapsed from the start of the processing executed by the adaptive equalization filter 80-n(1) as denoted by (4) above the broken-line arrow 106 near the averaging circuit 87 in FIG. 14. The coefficient update circuit 89 updates the coefficient for all the adaptive equalization filters 80-p based on the average signal Eav(1) using the above-mentioned formula (10). At that time, 5 clocks are lapsed from the start of the processing executed by the adaptive equalization filter 80-n(1) as denoted by (5) under the broken-line arrow 106 near the coefficient update circuit 89 in FIG. 14.

With a delay of (Ma−1) clocks after the calculation of the error signals Es(n(1)) by the error calculation circuits 85-n, the following process is executed based on output signals of the adaptive equalization filters 80-n(Ma) sharing respectively the error calculation circuits 85-n.

The error calculation circuits 85-n calculate error signals Es(n(Ma)) based on output signals of the adaptive equalization filters 80-n(Ma), respectively. At that time, (3+(Ma−1)) clocks are lapsed from the start of the processing executed by the adaptive equalization filters 80-n(1) as denoted, for example, on the left side of the arrow 109 in a one-dot-chain line near the error calculation circuit 85-Na in FIG. 14.

The averaging circuit 87 sums up the calculated error signals Es(1(Ma)) to Es(N(Ma)), including Es(Na(Ma)) and Es(Nb(Ma)), and averages the total sum, thereby calculating an average signal Eav(1 to Ma). At that time, (4+(Ma−1)) clocks are lapsed as denoted under the arrow 109 near the averaging circuit 87. The averaging circuit 87 outputs the average signal Eav(1 to Ma) to the coefficient update circuit 89.

The coefficient update circuit 89 adds the average signal Eav(1 to Ma), averaged by the averaging circuit 87, to the current coefficient, thereby calculating a new coefficient w(r+1) and updating the coefficient for all the adaptive equalization filters 80. More specifically, the coefficient update circuit 89 updates the coefficient of each adaptive equalization filter 80 using the above-mentioned formula (13). At that time, (5+(Ma−1)) clocks are lapsed as denoted above the arrow 109 near the coefficient update circuit 89 in FIG. 14.

Furthermore, in the case of Ma<Mb, with a delay of (Mb−1) clocks after the calculation of the error signals Es(n(1)) by the error calculation circuits 85-n, the following process is executed based on output signals of the adaptive equalization filters 80-n(Mb) sharing respectively the error calculation circuits 85-n.

The error calculation circuits 85-n calculate error signals Es(n(Mb)) based on output signals of the adaptive equalization filters 80-n(Mb), respectively. At that time, (3+(Mb−1)) clocks are lapsed from the start of the processing executed by the adaptive equalization filters 80-n(1) as denoted, for example, on the left side of the arrow 112 in a two-dot-chain line near the error calculation circuit 85-Nb in FIG. 14.

The averaging circuit 87 sums up the calculated error signals Es(n(Mb)) and averages the total sum, thereby calculating an average signal Eav(1 to Mb). Because of Na<Nb, there are no adaptive equalization filters 80 for which the error calculation is to be performed by the error calculation circuits 85-Na. When the sharing number Mb is a maximum sharing number, there are just the error signals Es(nb(Mb)) to be added in calculating the average signal Eav(1 to Mb).

At that time, (4+(Mb−1)) clocks are lapsed as denoted on the right side of the arrow 112 near the averaging circuit 87 in FIG. 14. The averaging circuit 87 outputs the average signal Eav(1 to Mb) to the coefficient update circuit 89.

The coefficient update circuit 89 adds the average signal Eav(1 to Mb), averaged by the averaging circuit 87, to the current coefficient, thereby calculating a new coefficient w(r+1) and updating the coefficient for all the adaptive equalization filters 80. More specifically, the coefficient update circuit 89 updates the coefficient of each adaptive equalization filter 80 using the above-mentioned formula (13). At that time, (5+(Mb−1)) clocks are lapsed as denoted under the arrow 112 near the coefficient update circuit 89 in FIG. 14. When the above-described process is completed regarding the maximum sharing number, the polarization demultiplexing circuit 54e then resumes the update of the coefficient based on the output signals of the adaptive equalization filters 80-n(1), thus repeating the above-described process.

With the second embodiment, the coefficient for the adaptive equalization filters 80 is updated as the “each-time update” in the polarization demultiplexing circuit 54e including the error calculation circuits 85 in different sharing numbers. In that case, assuming a maximum sharing number to be Mb, a delay time td is given by td=t+(Mb−1).

With the polarization demultiplexing circuit 54e according to the second embodiment, as described in detail above, the number N of error calculation circuits 85, N being not more than P, are provided for the number P of adaptive equalization filters 80. While one error calculation circuit 85 is provided for the sharing number Mn of adaptive equalization filters 80, the sharing number Mn set for each of the error calculation circuits 85-n may not be the same. Each error calculation circuit 85-n calculates error signals Es(n(mn)) (mn is an integer satisfying 1≦nm≦Mn) in a time division manner for the sharing number of adaptive equalization filters 80.

The averaging circuit 87 averages the calculated error signals Es(n(1)) to Es(n(mn)) per error calculation, thereby calculating an average signal Eav(1 to mn). On that occasion, when the sharing number Mn is relatively small and there are no adaptive equalization filters 80-n(mn), the corresponding error signals Es(n(mn)) are not added. The coefficient update circuit 89 updates the coefficient based on the calculated average signal Eav(1 to mn) using the formula of w(r+1)=w(r)+Eav(1 to mn). As a result, the coefficient for all the adaptive equalization filters 80 in the polarization demultiplexing circuit 54e is updated by the coefficient update circuit 89 at successive clocks during a period from the feedback delay t to td based on the error signals Es(n(1)) to Es(n(mn)) calculated up to that time.

Compare here characteristics between the case using only one of plural lanes of the adaptive equalization filters 80 without sharing the error calculation circuit 85 and the case sharing the error calculation circuit 85 in a time division manner. In the latter case, the feedback delay increases by (Mb−1) clocks, for example, while the number of adaptive equalization filters 80 used in the averaging process increases by (P−N). It is hence possible to utilize the fact that the effect of reducing degradation of signal quality, which is obtained by increasing the number of adaptive equalization filters 80 used in the averaging process, is more significant than the degradation of signal quality, which is caused by a longer feedback delay.

As a result, signal degradation is suppressed which has been inevitable when one error calculation circuit 85 is disposed for plural adaptive equalization filters 80 and the thinning process is executed. Thus, by sharing the error calculation circuit 85 and increasing the number of error signals used in the averaging circuit 87 to the number P of parallel developed signals at maximum, the Q value is increased and the capability of following to polarization variations is improved.

Also, when the number of error calculation circuits 85 to be incorporated is reduced due to restrictions taking into account the current technical level of integrated circuits and combined arrangement with other signal processing circuits, degradation of the signal quality is suppressed in a situation where the number of incorporated circuits is reduced. Moreover, even when incorporating the error calculation circuit 85 is allowed for each of all the adaptive equalization filters 80, it is realizable to overcome the problem that the presence of the error calculation circuits 85 may restrict the other signal processing circuits, thus degrading characteristics from ideal ones, and may increase power consumption.

In the optical transmission path, it is difficult to maintain the signal quality in some cases due to great influences of polarization rotation, polarization mode dispersion, and so on. Even in such a case, however, objective signal quality is maintained. Thus, since objective performance is achieved with the smaller number of incorporated error calculation circuits 85, an advantage of securing a space for incorporating other circuits with reduction of a circuit scale is also obtained. When other circuits and so on are not incorporated in the space secured by reducing the number of incorporated error calculation circuits 85, another advantage of saving the power consumption is obtained.

While the second embodiment has been described as updating the coefficient in the polarization demultiplexing circuit 54e with the “each-time update”, the coefficient may be updated with the “latch update”.

A modification of the configuration of the adaptive equalization filter 80 will be described below with reference to FIG. 15. FIG. 15 illustrates another example the configuration of the adaptive equalization filter 80. The FIR filter hxx provided in the butterfly-type filter 78 in FIG. 4 may be constituted like an FIR filter hxx2, for example, as illustrated in FIG. 15. The FIR filter hxx2 includes multipliers 131, 133 and 135, delay devices 137 and 139, and an adder 141. Each of the multipliers 131, 133 and 135 receives an input signal and a coefficient, and outputs an output signal resulting from multiplying the input signal by the coefficient. Each of the delay devices 137 and 139 delays the input signal by a predetermined time. The adder 141 outputs a signal obtained by adding input signals.

The other FIR filters hyx, hxy and hyy of the butterfly-type filter 78 may also have the same configuration as that described above. Alternatively, the adaptive equalization filter 80 itself may be constituted similarly to the FIR filter hxx2. In such a case, the coefficient update circuit 89 updates the coefficients of the multipliers 131, 133 and 135.

Modifications of the method for updating the coefficient of the adaptive equalization filter 80 will be described below. The case of calculating the error signal in accordance with the CMA method is first described. When the polarization demultiplexing circuit is operated by employing the CMA as an algorithm for making control to the optimum polarization state, the coefficient update formula is expressed by the following formula (14);

w(r+1)=w(r)+μy(r)(γ−|y(r)²|)x*(r) (14)

where μ denotes an adjustment coefficient, γ denotes an objective value, y(r) denotes a value of an output signal, x*(r) denotes a complex conjugate of an input signal, and r denotes a variable related to the number of times of update.

When the error signal is calculated in accordance with the MMA method, the polarization demultiplexing circuit is operated by employing the MMA as an algorithm for making control to the optimum polarization state. The coefficient update formula in the MMA is expressed by the following formula (15);

w(r+1)=w(r)+μ(y_{R}(r)(R_{R}−|y_{R}(r)²|)+jμy_{I}(r)(R_{I}−|y_{I}(r)|²))x*(r) (15)

where μ denotes an adjustment coefficient, R_{R} and R_{I} denote respectively a real part and an imaginary part of an objective value, y_{R}(r) and y_{I}(r) denote respectively a real part and an imaginary part of an output signal, x*(r) denotes a complex conjugate of an input signal, and r denotes a variable related to the number of times of update.

When the error signal is calculated in accordance with the RDE method, the polarization demultiplexing circuit is operated by employing the RDE as an algorithm for making control to the optimum polarization state. The coefficient update formula in the RDE is expressed by the following formula (16);

w(r+1)=w(r)+μy(r)(Rₐ−|y(r)²|)x*(r) (16)

where μ denotes an adjustment coefficient, Rₐ denotes an objective value, y(r) denotes a value of an output signal, x*(r) denotes a complex conjugate of an input signal, and r denotes a variable related to the number of times of update.

The polarization demultiplexing circuit may also be operated by employing another enhanced version of the CMA as an algorithm for making control to the optimum polarization state.

In the above-described first and second embodiment and the above-described modifications, the polarization demultiplexing circuits 54c to 54e are examples of a signal processing apparatus. The adaptive equalization filter 80 is an example of a computation executing unit, and the error calculation circuit 85 is an example of an individual computation determining unit. The averaging circuit 87 and the coefficient update circuit 89 are an example of an update unit.

It is to be noted that the present disclosure is not limited to the above-described embodiment and may be variously configured and embodied within the scope without departing from the gist of the disclosure. For example, the number of taps of the FIR filter in the adaptive equalization filter 80 may be variously modified to be several to several tens depending on a range to be compensated for. For example, when the polarization mode dispersion or the wavelength dispersion is to be compensated for to a larger extent, the adaptive equalization filter 80 is preferably modified to increase the number of taps. Such a modification enables not only the polarization demultiplexing, but also the polarization mode dispersion and the wavelength dispersion to be compensated for by the polarization demultiplexing circuit 54.

While, in the above-described first and second embodiment and the above-described modifications, two inputs are applied to the adaptive equalization filter 80, the number of inputs is not limited two. For example, when the configurations illustrated in FIGS. 5 and 15 are employed, one input is applied to the adaptive equalization filter 80. Thus, the number of inputs may be another suitable value.

The optical signal may be modulated using various methods. For example, there are PSK modulation, QAM modulation, and so on. Other modulation methods may also be used if they are adapted for the coefficient update method described in this specification.

FIG. 6 illustrates one example of the configuration, and the configuration may be modified such that all the signals are input to one S/P 70, or that the function of the S/P 70 is included in the digital signal processing circuit 40.

In the above-described first and second embodiment and the above-described modifications, the error calculation circuit 85 is described as executing the pipeline processing. The pipeline processing contributes to updating the input data per clock and shortening the feedback delay time, thus increasing the effect of suppressing degradation of signal characteristics.

When the pipeline processing is not executed, the next error signal is not calculated until the process of calculating the error signal in the error calculation circuit 85 is finished. Assuming, for example, that the process executed by the error calculation circuit 85 takes 3 clocks, the error signal is calculated per 3 clocks and the delay time is given by (feedback delay+(M (or Mb)−1)×3 clocks). However, degradation of signal quality is suppressed in comparison with the case of executing the thinning process.

Any of the above-described signal processing circuits is applicable to a system that includes a feedback mechanism and that has the feature, illustrated in FIG. 6, in characteristics of the delay and the averaging lane number, even when the signal processing executed by the polarization demultiplexing circuit 54 as in the above-described embodiment and modifications is not performed.

While, in the above-described first and second embodiment and the above-described modifications, the error signal Es is calculated based on the outputs of all the number P of adaptive equalization filters 80 incorporated, the calculation method is not limited to the described one. For example, a method of calculating the error signal Es based on the outputs of the number K of adaptive equalization filters 80, K being smaller than P, may also be used insofar as the desired signal characteristics are obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A signal processing apparatus, comprising:
a number P of adaptive equalization filters, P being 2 or more, configured to execute a first computing process for equalization on respective input signals, and to issue output signals;
a number N of error calculation circuits, N being not more than P, configured to determine, per adaptive equalization filter, a second computing process to calculate an error in order to reduce a difference between a value of the output signal obtained with the first computing process and a predetermined objective value of the output signal; and
an update circuit configured to determine a third computing process based on the second computing process determined per adaptive equalization filter by the error calculation circuit, and to update a computing process, which is executed in the adaptive equalization filter, to the third computing process.

2. The signal processing apparatus according to claim 1, wherein the second computing process for each of the number K of adaptive equalization filters, K being not more than P, is determined by one of the number N of error calculation circuits, and
each of the number N of error calculation circuits successively determines the second computing process for each of the adaptive equalization filters in a time division manner.

3. The signal processing apparatus according to claim 1, wherein P is integer time N, and the error calculation circuit successively determines the second computing processes for the number M of adaptive equalization filters in a time division manner, M being given by dividing P by N.

4. The signal processing apparatus according to claim 1, wherein the update circuit successively determines the third computing process in a time division manner based on the second computing process having been successively determined in a time division manner, and
the update circuit successively updates the computing process executed in the adaptive equalization filters to the third computing process, which has been successively determined in a time division manner in the update circuit, until the second computing processes are determined for the number K of adaptive equalization filters and the third computing process is determined in the update circuit based on the number K of second computing processes.

5. The signal processing apparatus according to claim 1, wherein the update circuit determines the third computing process after the second computing processes corresponding to the number K of adaptive equalization filters have been all determined by the error calculation circuit, and
when the third computing process is determined, the update circuit updates the computing process executed in the adaptive equalization filters to the third computing process having been determined in the update circuit.

6. The signal processing apparatus according to claim 1, wherein each of the number P of adaptive equalization filters includes at least one finite impulse response filter, and
one of the number N of error calculation circuits calculates differences between the values of the output signals of the number K of adaptive equalization filters, K being not more than P, and the objective values thereof, and
the update circuit determines the coefficient of the finite impulse response filter in each of the number P of adaptive equalization filters based on the calculated differences between the values of the output signals of the number K of adaptive equalization filters and the objective values thereof.

7. The signal processing apparatus according to claim 6, wherein the update circuit averages the differences calculated by the error calculation circuit, and
the update circuit updates the coefficient of the finite impulse response filter to the coefficient determined by the update circuit.

8. The signal processing apparatus according to claim 6, wherein each of the number P of adaptive equalization filters includes a butterfly-type finite impulse response filter.

9. The signal processing apparatus according to claim 8, wherein the input signals are signals subjected to quadrature phase modulation.

10. The signal processing apparatus according to claim 1, wherein the input signals are signals obtained by converting temporally continued signals into the P number of parallel developed signals.

11. A receiver, comprising:
a plurality of digital filters;
a serial parallel converter configured to perform serial parallel conversion on received signals and to distribute the received signals to the plurality of digital filters;
an error calculation circuit configured to calculate an error between an output signal of each of the plurality of digital filters and an objective signal;
an update circuit configured to, based on an average of plural errors calculated by the error calculation circuit, update a filter coefficient given to the plurality of digital filters such that the error is reduced; and
a reproducing circuit configured to, based on the output signals of the plurality of digital filters, data having been transmitted with the received signals,
wherein each of the plurality of digital filters executes filter computation on the received signal using a filter coefficient updated by the update circuit.

12. A signal processing method, comprising:
causing a number P of adaptive equalization filters, P being 2 or more, to execute a first computing process for equalization on respective input signals, and to issue output signals;
causing a number N of error calculation circuits, N being not more than P, to determine, per adaptive equalization filter, a second computing process to reduce a difference between a value of the output signal obtained with the first computing process and a predetermined objective value of the output signal;
causing an update circuit to determine a third computing process based on the second computing process determined per adaptive equalization filter by the error calculation circuit, and to update a computing process, which is executed in the adaptive equalization filter, to the third computing process;
causing one of the number N of error calculation circuits to determine the second computing process for each of the number K of adaptive equalization filters, K being not more than P; and
causing each of the number N of error calculation circuits to successively determine the second computing process for each of the adaptive equalization filters in a time division manner.

13. The signal processing method according to claim 12, wherein P is integer time N, and the error calculation circuit successively determines the second computing processes for the number M of adaptive equalization filters in a time division manner, M being given by dividing P by N.

14. The signal processing method according to claim 12, wherein the third computing process is successively determined in a time division manner based on the second computing process having been successively determined in a time division manner, and
the computing process executed in the adaptive equalization filters is successively updated to the third computing process, which has been successively determined in a time division manner, until the second computing processes are determined for the number K of adaptive equalization filters and the third computing process is determined based on the number K of second computing processes.

15. The signal processing method according to claim 12, wherein the third computing process is determined after the second computing processes corresponding to the number K of adaptive equalization filters have been all determined by the error calculation circuit, and
when the third computing process is determined, the computing process executed in the adaptive equalization filters is updated to the third computing process having been determined.

16. The signal processing method according to claim 12, wherein one of the number N of error calculation circuits calculates differences between the values of the output signals of the number K of adaptive equalization filters and the objective values thereof, and
a coefficient of a finite impulse response filter in each of the number P of adaptive equalization filters is determined based on the calculated differences between the values of the output signals of the number K of adaptive equalization filters and the objective values thereof.
